(19) United States
(12) Patent Application Publication
(10) Pub. No.: US 2026/0073793 A1
(43) Pub. Date: Mar. 12, 2026

(54) Parking Space Recommendation Method and Apparatus, and Vehicle

(71) Applicant: HUAWEI TECHNOLOGIES CO., LTD., Shenzhen (CN)

(72) Inventors: Wenjun Wan, Beijing (CN); Rongwei Guo, Beijing (CN); Xingliang Dong, Shenzhen (CN); Shukun Tan, Shenzhen (CN)

(73) Assignee: HUAWEI TECHNOLOGIES CO., LTD., Shenzhen (CN)

(21) Appl. No.: 19/386,803

(22) Filed: Nov. 12, 2025

Related U.S. Application Data
(63) Continuation of application No. PCT/CN2025/075533, filed on Jan. 27, 2025.

(30) Foreign Application Priority Data
Feb. 6, 2024 (CN) 202410173921.1

(51) Int. Cl. G08G 1/14; B60W 30/06; B60W 50/14; G08G 1/0969

(52) U.S. Cl. CPC G08G 1/143; B60W 30/06; B60W 50/14; G08G 1/0969; G08G 1/146; B60W 2050/146; B60W 2540/215; B60W 2556/10; B60W 2556/40

(57) ABSTRACT

A parking space recommendation method includes receiving a map of a parking lot and information about an available parking space and an unavailable parking space in the parking lot from a server, where the parking lot is a parking lot into which a first vehicle currently travels, the available parking space includes a temporary parking space, which is obtained by dividing an area in the parking lot other than a marked parking space; and displaying the map of the parking lot, and presenting the unavailable parking space, the available parking space, and a parking priority of the available parking space on the map. The temporary parking space in the parking lot is obtained through division and is displayed on a vehicle side.

### CROSS-REFERENCE TO RELATED APPLICATIONS

This is a continuation of International Patent Application No. PCT/CN2025/075533 filed on Jan. 27, 2025, which claims priority to Chinese Patent Application No. 202410173921.1 filed on Feb. 6, 2024. The disclosures of the aforementioned applications are hereby incorporated by reference in their entireties.

### TECHNICAL FIELD

This application relates to the technical field of information technology (IT), and in particular, to a parking space recommendation method and apparatus, and a vehicle.

### BACKGROUND

In recent years, with the popularization of intelligent vehicles, people enjoy auto parking systems such as automated valet parking (AVP) and auto parking assist (APA) of the intelligent vehicles, and also find that parking space shortage becomes more serious. Sensors such as a lidar and a camera that are mounted on an auto parking system may recognize a parking space, and then may be used to park a vehicle into the parking space through planning and control means.

Currently, before driving a vehicle into a parking lot, a vehicle owner does not know a location of an available parking space in the parking lot. As a result, the vehicle owner needs to spend a large amount of time searching for the parking space. In addition, when there is a plurality of candidate parking spaces, the vehicle owner may directly consider parking the vehicle at a nearest location. Therefore, even if the vehicle owner finally finds a parking space and successfully parks the vehicle into the parking space, from a perspective of management of the entire parking lot, the parking space is not an optimal parking space, and another parking space may be blocked. As a result, a subsequent vehicle owner cannot find a suitable parking space, and utilization of parking spaces in the parking lot is reduced. Therefore, how to improve utilization of parking spaces in a parking lot is a technical problem that urgently needs to be resolved currently.

### SUMMARY

This disclosure provides a parking space recommendation method and apparatus, a vehicle, a computer storage medium, and a computer product, to improve utilization of parking spaces in a parking lot.

According to a first aspect, this disclosure provides a parking space recommendation method. The method includes receiving a map of a parking lot and information about an available parking space and an unavailable parking space in the parking lot from a server (for example, delivered by the server), where the parking lot is a parking lot into which a first vehicle currently travels, the available parking space includes a temporary parking space, and the temporary parking space is obtained by dividing an area in the parking lot other than a marked parking space; and displaying the map of the parking lot, and presenting the unavailable parking space, the available parking space, and a parking priority of the available parking space on the map.

In this way, the temporary parking space in the parking lot is obtained through division and is displayed on a vehicle side, so that a user can learn of a location that can be used for parking in the parking lot other than the marked parking space. This increases a quantity of available parking spaces in the parking lot and improves utilization of parking spaces in the parking lot.

In a possible implementation, on the map, an identifier of the available parking space is different from an identifier of the unavailable parking space. In other words, the available parking space and the unavailable parking space may be displayed on the map with different identifiers. In this way, the user can intuitively learn of a location that can be used for parking. This improves parking efficiency.

In a possible implementation, on the map and in the available parking space, first identifiers of different temporary parking spaces are different, and the first identifier indicates a parking priority of the temporary parking space. In this way, the temporary parking spaces are graded, so that the user can learn of a temporary parking space that is suitable for preferential parking and that has low impact on another vehicle. This reduces a probability of mutual impact between vehicles in the parking lot.

In a possible implementation, the available parking space further includes a marked parking space; and on the map and in the available parking space, an identifier of the marked parking space is different from an identifier of the temporary parking space. In this way, the user can intuitively learn of a marked parking space and a temporary parking space, to facilitate decision-making of the user.

In a possible implementation, second identifiers of different marked parking spaces are different, and the second identifier indicates a parking priority of the marked parking space. In this way, the user can learn of a location suitable for parking of the user, to improve parking efficiency.

In a possible implementation, a parking priority of the marked parking space is higher than the parking priority of the temporary parking space. In this way, the user can preferentially park into the marked parking space, to reduce a case in which the user parks the vehicle into the temporary parking space, which affects another vehicle.

In a possible implementation, the parking priority of the available parking space is determined based on one or more of occupation duration of the unavailable parking space and a historical parking habit of a user of the first vehicle. In this way, the parking priority of the available parking space may be indirectly determined based on the occupation duration of the unavailable parking space, or the parking priority of the available parking space may be determined based on the parking habit of the user.

In a possible implementation, an identifier of a vehicle is displayed on the unavailable parking space on the map. In this way, the user can intuitively learn of a location at which a vehicle is parked, to improve user experience.

In a possible implementation, after presenting the available parking space on the map, the method further includes, in response to an operation of selecting a first parking space from the available parking space by the user, parking the first vehicle into the first parking space. For example, a process of parking into the parking space may be independently completed by the first vehicle.

In a possible implementation, after parking the first vehicle into the first parking space, the method further includes sending, to the server, a local map of the parking lot constructed by the first vehicle and perception data related to a sensor of the first vehicle, so that the server updates information about the map of the parking lot and the available parking space and the unavailable parking space in the parking lot. In this way, the server can update the information about the parking lot in time, so that a vehicle that subsequently travels into the parking lot can obtain a latest map and parking space information.

In a possible implementation, after parking the first vehicle into the first parking space, the method further includes receiving a vehicle movement request from the server when the first vehicle blocks a leaving route for a second vehicle to leave a second parking space; and parking the first vehicle into a third parking space recommended by the server. In this way, independent vehicle movement of the vehicle can be implemented, a probability of mutual impact between vehicles is reduced, and user experience is improved. For example, the independent vehicle movement may be completed with authorization of the user.

In a possible implementation, after parking the first vehicle into the first parking space, the method further includes receiving a vehicle movement request from the server when the first vehicle blocks a leaving route for a second vehicle to leave a second parking space; driving the first vehicle away from the first parking space for staying outside the leaving route; and when the second vehicle passes through the first parking space, parking the first vehicle into the first parking space, or when the second vehicle leaves the second parking space and a route for parking the first vehicle into the second parking space does not affect a subsequent leaving route of the second vehicle, parking the first vehicle into the second parking space. In this way, independent vehicle movement of the vehicle can be implemented, a probability of mutual impact between vehicles is reduced, and user experience is improved. For example, the independent vehicle movement may be completed with authorization of the user.

According to a second aspect, this disclosure provides a parking space recommendation method. The method includes receiving a vehicle movement request from a server; and in response to the vehicle movement request, parking a first vehicle from a first parking space in which the first vehicle is currently located into a second parking space, where a parking priority of the second parking space is higher than a parking priority of the first parking space, and the first parking space and the second parking space are located in a same parking lot.

In this way, when there is a parking space whose parking priority is higher than a parking priority of the parking space in which the first vehicle is currently located in the parking lot, the first vehicle can be parked into the parking space whose parking priority is higher, so that utilization of a parking space can be improved, usage of a parking space in the parking lot can be improved, and utilization of the parking spaces in the parking lot can be improved.

In a possible implementation, the vehicle movement request is received after information about an available parking space in the parking lot is updated and no vehicle is parked in the second parking space; or the vehicle movement request is received when a user chooses, on a terminal device, to move the first vehicle to the second parking space. In this way, when determining that there is a parking space whose parking priority is higher, the server may park the first vehicle into the parking space whose parking priority is higher. In addition, the server may send the parking space whose priority is higher determined by the server to the terminal device used by the user, so that the user determines whether to park into the parking space whose parking priority is higher. For example, the server may update information about a parking space in the parking lot in real time or periodically, and recalculate parking priorities of all available parking spaces. In addition, when a user refuses to park into the parking space whose parking priority is higher, the server may notify a next user, so that the next user determines whether to park into the parking space whose parking priority is higher. A sequence of notifying a user may be determined based on parking duration. For example, a user with shorter parking duration may be notified first, and then a user with longer parking duration may be notified. In an example, when the user is not satisfied with a parking space in which the user currently parks, the user may alternatively manually choose another available parking space on the terminal device. Then, the server may treat the parking space selected by the user as a parking space whose parking priority is higher.

In a possible implementation, the second parking space is a parking space in which a second vehicle is parked, and the vehicle movement request is received when the first vehicle blocks a leaving route for the second vehicle to leave the second parking space. In this case, parking the first vehicle from the first parking space in which the first vehicle is currently located to the second parking space includes driving the first vehicle away from the first parking space for staying outside the leaving route; and when the second vehicle passes through the first parking space, parking the first vehicle into the first parking space, or when the second vehicle leaves the second parking space and a route for parking the first vehicle into the second parking space does not affect a subsequent leaving route of the second vehicle, parking the first vehicle into the second parking space. In this way, independent vehicle movement of the vehicle can be implemented, a probability of mutual impact between vehicles is reduced, and user experience is improved. For example, the independent vehicle movement may be completed with authorization of the user.

According to a third aspect, this disclosure provides a parking space recommendation method, applied to a server. The method includes receiving a parking space recommendation request from a first vehicle; and sending, to the first vehicle, a map of a parking lot into which the first vehicle travels, and information about an available parking space and an unavailable parking space in the parking lot, where the available parking space includes a temporary parking space, and the temporary parking space is obtained by the server by dividing an area in the parking lot other than a marked parking space.

In a possible implementation, the method further includes receiving, from the first vehicle, perception data related to a sensor of the first vehicle and a local map of the parking lot; updating, based on the perception data related to the sensor of the first vehicle, the information about the available parking space and the unavailable parking space in the parking lot; and updating the map of the parking lot based on the local map of the parking lot.

In a possible implementation, before sending, to the first vehicle, the map of the parking lot into which the first vehicle travels, and the information about the available parking space and the unavailable parking space in the parking lot, the method further includes receiving, from another vehicle, a local map of the parking lot and perception data related to a sensor of the other vehicle, where the other vehicle is at least one vehicle other than the first vehicle; generating the map of the parking lot based on the local map of the parking lot sent by the other vehicle; and recognizing the available parking space and the unavailable parking space in the parking lot based on the perception data related to the sensor of the other vehicle.

In a possible implementation, after recognizing the available parking space in the parking lot, the method further includes dividing parking priorities of parking spaces included in the available parking space.

In a possible implementation, the method further includes indicating, when a first parking space in which the first vehicle is located blocks a leaving route for a second vehicle to leave a second parking space, the first vehicle to travel from the first parking space to a third parking space, and stay in the third parking space, where the third parking space is not on the leaving route.

In a possible implementation, the method further includes indicating, when a first parking space in which the first vehicle is located blocks a leaving route for a second vehicle to leave a second parking space, the first vehicle to travel to an area outside the leaving route; and indicating, when the second vehicle passes through the first parking space, the first vehicle to be parked into the first parking space; or indicating, when the second vehicle leaves the second parking space and a route for parking the first vehicle into the second parking space does not affect a subsequent leaving route of the second vehicle, the first vehicle to be parked into the second parking space.

In a possible implementation, after the second vehicle leaves the second parking space, the method further includes updating the information about the available parking space and the unavailable parking space in the parking lot.

According to a fourth aspect, this disclosure provides a parking space recommendation method, applied to a server. The method includes determining that a vehicle movement condition of a first vehicle is met, where the first vehicle is parked in a first parking space in a parking lot, and the vehicle movement condition includes one or more of the following such as the first vehicle blocks a leaving route for a second vehicle to leave a parking space in which the second vehicle is located, there is an available parking space whose parking priority is higher than a parking priority of the first parking space after information about an available parking space in the parking lot is updated, and an instruction instructing to move the vehicle is received from a terminal device; and sending a vehicle movement request to the first vehicle, where the vehicle movement request at least indicates to park the first vehicle from the first parking space into a second parking space, a parking priority of the second parking space is higher than the parking priority of the first parking space, and the second parking space is a historical parking space of the second vehicle or another vehicle, or the second parking space is an available parking space selected by a user on the terminal device.

In a possible implementation, the vehicle movement condition is that the first vehicle blocks the route for the second vehicle to leave the parking space in which the second vehicle is located. In this case, the vehicle movement request indicates to first drive the first vehicle to an area outside the leaving route, and then park the first vehicle into the second parking space when the second vehicle leaves the second parking space and a route for parking the first vehicle into the second parking space does not affect a subsequent leaving route of the second vehicle.

According to a fifth aspect, this disclosure provides a parking space recommendation apparatus, including a communication module and a processing module. The communication module is configured to receive a map of a parking lot and information about an available parking space and an unavailable parking space in the parking lot from a server (for example, delivered by the server), where the parking lot is a parking lot into which a first vehicle currently travels, the available parking space includes a temporary parking space, and the temporary parking space is obtained by dividing an area in the parking lot other than a marked parking space. The processing module is configured to display the map of the parking lot, and present the unavailable parking space, the available parking space, and a parking priority of the available parking space on the map.

In a possible implementation, on the map, an identifier of the available parking space is different from an identifier of the unavailable parking space.

In a possible implementation, on the map and in the available parking space, first identifiers of different temporary parking spaces are different, and the first identifier indicates a parking priority of the temporary parking space.

In a possible implementation, the available parking space further includes a marked parking space; and on the map and in the available parking space, an identifier of the marked parking space is different from an identifier of the temporary parking space.

In a possible implementation, second identifiers of different marked parking spaces are different, and the second identifier indicates a parking priority of the marked parking space.

In a possible implementation, a parking priority of the marked parking space is higher than the parking priority of the temporary parking space.

In a possible implementation, an identifier of a vehicle is displayed on the unavailable parking space on the map.

In a possible implementation, the processing module is further configured to, after presenting the available parking space on the map, in response to an operation of selecting a first parking space from the available parking space by a user, park the first vehicle into the first parking space.

In a possible implementation, the communication module is further configured to, after the processing module parks the first vehicle into the first parking space, send, to the server, a local map of the parking lot constructed by the first vehicle and perception data related to a sensor of the first vehicle, so that the server updates information about the map of the parking lot and the available parking space and the unavailable parking space in the parking lot.

In a possible implementation, after the processing module parks the first vehicle into the first parking space, and when the first vehicle blocks a leaving route for a second vehicle to leave a second parking space, the communication module is further configured to receive a vehicle movement request from the server; and the processing module is further configured to park the first vehicle into a third parking space recommended by the server.

In a possible implementation, after the processing module parks the first vehicle into the first parking space, and when the first vehicle blocks a leaving route for a second vehicle to leave a second parking space, the communication module is further configured to receive a vehicle movement request from the server; and the processing module is further configured to drive the first vehicle away from the first parking space for staying outside the leaving route; and when the second vehicle passes through the first parking space, park the first vehicle into the first parking space, or when the second vehicle leaves the second parking space and a route for parking the first vehicle into the second parking space does not affect a subsequent leaving route of the second vehicle, park the first vehicle into the second parking space.

In a possible implementation, the parking priority of the available parking space is determined based on one or more of occupation duration of the unavailable parking space and a historical parking habit of a user of the first vehicle.

According to a sixth aspect, this disclosure provides a parking space recommendation apparatus, including a communication module and a processing module. The communication module is configured to receive a vehicle movement request from a server. The processing module is configured to, in response to the vehicle movement request, park a first vehicle from a first parking space in which the first vehicle is currently located into a second parking space, where a parking priority of the second parking space is higher than a parking priority of the first parking space, and the first parking space and the second parking space are located in a same parking lot.

In a possible implementation, the vehicle movement request is received after information about an available parking space in the parking lot is updated and no vehicle is parked in the second parking space; or the vehicle movement request is received when a user chooses, on a terminal device, to move the first vehicle to the second parking space.

In a possible implementation, the second parking space is a parking space in which a second vehicle is parked, and the vehicle movement request is received when the first vehicle blocks a leaving route for the second vehicle to leave the second parking space. In this case, when parking the first vehicle from the first parking space in which the first vehicle is currently located to the second parking space, the processing module is specifically configured to drive the first vehicle away from the first parking space for staying outside the leaving route; and when the second vehicle passes through the first parking space, park the first vehicle into the first parking space, or when the second vehicle leaves the second parking space and a route for parking the first vehicle into the second parking space does not affect a subsequent leaving route of the second vehicle, park the first vehicle into the second parking space.

According to a seventh aspect, this disclosure provides a parking space recommendation apparatus, deployed on a server, and including a communication module and a processing module. The processing module is configured to divide an area in a parking lot other than a marked parking space to obtain at least one temporary parking space. The communication module is configured to receive a parking space recommendation request from a first vehicle; and send, to the first vehicle, a map of the parking lot into which the first vehicle travels, and information about an available parking space and an unavailable parking space in the parking lot, where the available parking space includes a temporary parking space.

In a possible implementation, the communication module is further configured to receive, from the first vehicle, perception data related to a sensor of the first vehicle and a local map of the parking lot. The processing module is configured to update, based on the perception data related to the sensor of the first vehicle, the information about the available parking space and the unavailable parking space in the parking lot; and update the map of the parking lot based on the local map of the parking lot.

In a possible implementation, before the communication module sends, to the first vehicle, the map of the parking lot into which the first vehicle travels, and the information about the available parking space and the unavailable parking space in the parking lot, the communication module is further configured to receive, from another vehicle, a local map of the parking lot and perception data related to a sensor of the other vehicle, where the other vehicle is at least one vehicle other than the first vehicle; and the processing module is further configured to generate the map of the parking lot based on the local map of the parking lot sent by the other vehicle; and recognize the available parking space and the unavailable parking space in the parking lot based on the perception data related to the sensor of the other vehicle.

In a possible implementation, after recognizing the available parking space in the parking lot, the processing module is further configured to divide parking priorities of parking spaces included in the available parking space.

In a possible implementation, the processing module is further configured to indicate, when a first parking space in which the first vehicle is located blocks a leaving route for a second vehicle to leave a second parking space, the first vehicle to travel from the first parking space to a third parking space, and stay in the third parking space, where the third parking space is not on the leaving route.

In a possible implementation, the processing module is further configured to indicate, when a first parking space in which the first vehicle is located blocks a leaving route for a second vehicle to leave a second parking space, the first vehicle to travel to an area outside the leaving route; and indicate, when the second vehicle passes through the first parking space, the first vehicle to be parked into the first parking space; or indicate, when the second vehicle leaves the second parking space and a route for parking the first vehicle into the second parking space does not affect a subsequent leaving route of the second vehicle, the first vehicle to be parked into the second parking space.

In a possible implementation, after the second vehicle leaves the second parking space, the processing module is further configured to update the information about the available parking space and the unavailable parking space in the parking lot.

According to an eighth aspect, this disclosure provides a parking space recommendation apparatus, deployed on a server, and including a processing module and a communication module. The processing module is configured to determine that a vehicle movement condition of a first vehicle is met, where the first vehicle is parked in a first parking space in a parking lot, and the vehicle movement condition includes one or more of the following such as the first vehicle blocks a leaving route for a second vehicle to leave a parking space in which the second vehicle is located, there is an available parking space whose parking priority is higher than a parking priority of the first parking space after information about an available parking space in the parking lot is updated, and an instruction instructing to move the vehicle is received from a terminal device. The communication module is configured to send a vehicle movement request to the first vehicle, where the vehicle movement request at least indicates to park the first vehicle from the first parking space into a second parking space, a parking priority of the second parking space is higher than the parking priority of the first parking space, and the second parking space is a historical parking space of the second vehicle or another vehicle, or the second parking space is an available parking space selected by a user on the terminal device.

In a possible implementation, the vehicle movement condition is that the first vehicle blocks the route for the second vehicle to leave the parking space in which the second vehicle is located. In this case, the vehicle movement request indicates to first drive the first vehicle to an area outside the leaving route, and then park the first vehicle into the second parking space when the second vehicle leaves the second parking space and a route for parking the first vehicle into the second parking space does not affect a subsequent leaving route of the second vehicle.

According to a ninth aspect, this disclosure provides a parking space recommendation apparatus. The apparatus includes one or more processors and a memory configured to store one or more programs. When the one or more programs are executed by the one or more processors, the one or more processors are enabled to implement the method described in any one of the first aspect or the possible implementations of the first aspect, or implement the method described in any one of the third aspect or the possible implementations of the third aspect. For example, when the parking space recommendation apparatus can implement the method described in any one of the first aspect or the possible implementations of the first aspect, the parking space recommendation apparatus may be but is not limited to a vehicle-mounted terminal on a vehicle. When the parking space recommendation apparatus can implement the method described in any one of the third aspect or the possible implementations of the third aspect, the parking space recommendation apparatus may be but is not limited to a server, for example, a cloud server.

According to a tenth aspect, this disclosure provides a parking space recommendation apparatus. The apparatus includes one or more processors and a memory configured to store one or more programs. When the one or more programs are executed by the one or more processors, the one or more processors are enabled to implement the method described in any one of the second aspect or the possible implementations of the second aspect, or implement the method described in any one of the fourth aspect or the possible implementations of the fourth aspect. For example, when the parking space recommendation apparatus can implement the method described in any one of the second aspect or the possible implementations of the second aspect, the parking space recommendation apparatus may be but is not limited to a vehicle-mounted terminal on a vehicle. When the parking space recommendation apparatus can implement the method described in any one of the fourth aspect or the possible implementations of the fourth aspect, the parking space recommendation apparatus may be but is not limited to a server, for example, a cloud server.

According to an eleventh aspect, this disclosure provides a vehicle, including the parking space recommendation apparatus that can implement the method described in any one of the first aspect or the possible implementations of the first aspect and that is described in the ninth aspect, or including the parking space recommendation apparatus that can implement the method described in any one of the second aspect or the possible implementations of the second aspect and that is described in the tenth aspect.

According to a twelfth aspect, this disclosure provides a computer-readable storage medium, including computer program instructions. When the computer program instructions are executed by a computing device, the computing device performs the method described in any one of the first aspect or the possible implementations of the first aspect, or performs the method described in any one of the second aspect or the possible implementations of the second aspect, or performs the method described in any one of the third aspect or the possible implementations of the third aspect, or performs the method described in any one of the fourth aspect or the possible implementations of the fourth aspect.

According to a thirteenth aspect, this disclosure provides a computer program product including instructions. When the instructions are run by a computing device, the computing device is enabled to perform the method described in any one of the first aspect or the possible implementations of the first aspect, or perform the method described in any one of the second aspect or the possible implementations of the second aspect, or perform the method described in any one of the third aspect or the possible implementations of the third aspect, or perform the method described in any one of the fourth aspect or the possible implementations of the fourth aspect.

It may be understood that, for beneficial effect of the third aspect to the thirteenth aspect, reference may be made to related descriptions in the first aspect or the second aspect. Details are not described herein again.

### BRIEF DESCRIPTION OF DRAWINGS

FIG. 1 is a diagram of an application scenario according to an embodiment of this disclosure;

FIG. 2 is a diagram of a hardware structure of a vehicle according to an embodiment of this disclosure;

FIG. 3 is a diagram of a hardware structure of a server according to an embodiment of this disclosure;

FIG. 4 is a schematic flowchart of a parking method according to an embodiment of this disclosure;

FIG. 5A to FIG. 5C are diagrams of a change of an interface presented by a vehicle in a parking lot according to an embodiment of this disclosure;

FIG. 6 is a diagram of steps of grading available parking spaces according to an embodiment of this disclosure;

FIG. 7 is another diagram of steps of grading available parking spaces according to an embodiment of this disclosure;

FIG. 8A and FIG. 8B are diagrams of steps of a vehicle pulling-out method according to an embodiment of this disclosure;

FIG. 9A to FIG. 9D are diagrams of a vehicle pulling-out process according to an embodiment of this disclosure;

FIG. 10 is a diagram of a structure of a parking space recommendation apparatus according to an embodiment of this disclosure; and

FIG. 11 is a diagram of a structure of another parking space recommendation apparatus according to an embodiment of this disclosure.

### DESCRIPTION OF EMBODIMENTS

The term “and/or” in this specification describes an association relationship between associated objects and indicates that three relationships may exist. For example, A and/or B may indicate the following three cases: Only A exists, both A and B exist, and only B exists. The character “/” in this specification indicates an “or” relationship between the associated objects. For example, A/B indicates A or B.

In the specification and claims of this disclosure, the terms “first”, “second”, and the like are used for distinguishing between different objects, but are not used for describing a particular order of the objects. For example, a first response message, a second response message, and the like are used for distinguishing between different response messages, but are not used for describing a particular order of the response messages.

In embodiments of this disclosure, the word “example”, “for example” or the like is used to represent giving an example, an illustration, or a description. Any embodiment or design scheme described as an “example” or “for example” in embodiments of this disclosure should not be explained as being more preferred or having more advantages than another embodiment or design scheme. Exactly, use of the word “example”, “for example”, or the like is intended to present a related concept in a specific manner.

In the descriptions of embodiments of this disclosure, unless otherwise specified, “a plurality of” means two or more. For example, a plurality of processing units are two or more processing units, and a plurality of elements are two or more elements.

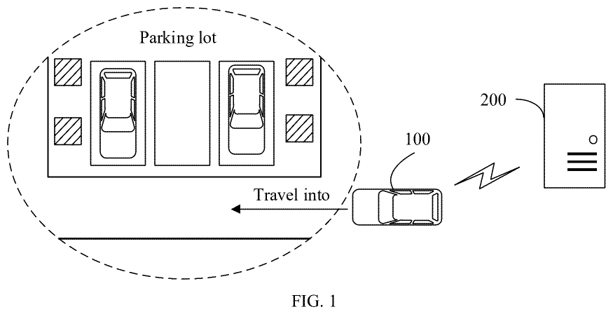

For example, FIG. 1 is a diagram of an application scenario according to an embodiment of this disclosure. As shown in FIG. 1, a vehicle 100 may travel into a parking lot, and be parked into a parking space in the parking lot. The vehicle 100 may establish a communication connection with a server 200 through a network. In the application scenario shown in FIG. 1, after traveling into the parking lot, the vehicle 100 may perceive environment information in the parking lot and traveling information of the vehicle 100 in the parking lot by using a sensor (for example, a camera or a radar) on the vehicle, and process perception data of the sensor according to a preset algorithm, to construct a local map of the parking lot. In addition, the vehicle 100 may further upload the perception data of the sensor in the vehicle and the constructed local map to a server 200. The server 200 may splice and combine local maps that are of a same parking lot and that are uploaded by different vehicles, to obtain a complete map of the parking lot. In addition, the server 200 may further process perception data and the like that are uploaded by the different vehicles, to recognize an available parking space (for example, an available marked parking space and a temporary parking space) in the parking lot. The temporary parking space is a part of an unmarked area that can be used to temporarily park a vehicle in the parking lot. Further, the server 200 may recommend all available parking spaces to the vehicle 100 or a user, or may select a parking space suitable for the vehicle 100 from the available parking spaces, and recommend the parking space to the vehicle 100 or the user. It should be understood that the parking lot described in FIG. 1 may be an indoor parking lot or an outdoor parking lot. This is not limited herein.

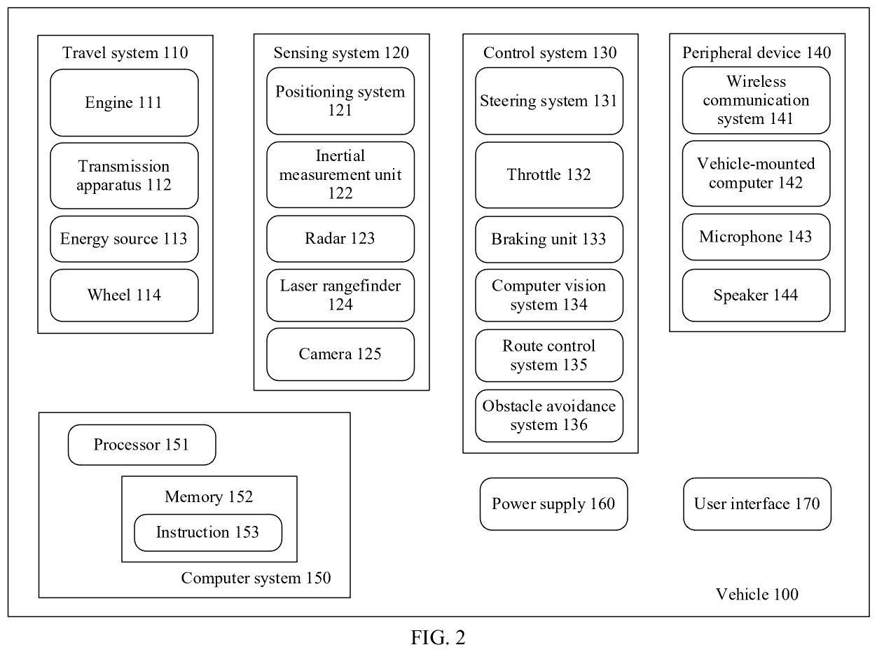

For example, FIG. 2 is a diagram of a hardware architecture of a vehicle according to an embodiment of this disclosure. As shown in FIG. 2, the vehicle 100 may include various subsystems, for example, a travel system 110, a sensing system 120, a control system 130, one or more peripheral devices 140, a power supply 160, a computer system 150, and a user interface 170. Optionally, the vehicle 100 may include more or less subsystems, and each subsystem may include a plurality of elements. In addition, each subsystem and element of the vehicle 100 may be interconnected in a wired or wireless manner.

The travel system 110 may include components configured to provide power motion to the vehicle 100. In some embodiments, the travel system 110 may include an engine 111, a transmission apparatus 112, an energy source 113, and a wheel 114/tire. The engine 111 may be an internal combustion engine, an electric motor, an air compression engine, or a combination of other types of engines, for example, a hybrid engine including a gasoline engine and an electric motor, or a hybrid engine including an internal combustion engine and an air compression engine. The engine 111 may convert the energy source 113 into mechanical energy. The energy source 113 may include gasoline, diesel, another petroleum-based fuel, propane, another compressed gas-based fuel, anhydrous alcohol, a solar panel, a battery, and another power source. The energy source 113 may also provide energy to another system of the vehicle 100.

The transmission apparatus 112 may include a gearbox, a differential, and a drive shaft, where the transmission apparatus 112 may transmit mechanical power from the engine 111 to the wheel 114. The drive shaft may include one or more shafts that may be coupled to one or more wheels 114. In some embodiments, the transmission apparatus 112 may further include another component, for example, a clutch.

The sensing system 120 may include several sensors that sense information about an ambient environment of the vehicle 100. For example, the sensing system 120 may include a positioning system 121 (for example, a Global Positioning System (GPS), a BEIDOU system, or another positioning system), an inertial measurement unit (IMU) 122, a radar 123 (for example, a lidar or an ultrasonic radar), a laser rangefinder 124, and a camera 125 (for example, a fisheye camera or a front-facing camera). The sensing system 120 may further include a sensor (for example, a vehicle-mounted air quality monitor, a fuel gauge, or an oil temperature gauge) of an internal system of the vehicle 100. Sensor data from one or more of these sensors can be used to detect an object and corresponding characteristics (a location, a shape, a direction, a speed, and the like) of the object. Such detection and recognition are key functions of a safe operation of the autonomous vehicle 100. In embodiments, the sensing system 120 may be used to sense at least environment information in the parking lot. The positioning system 121 may be configured to estimate a geographical location of the vehicle 100. The IMU 122 may be configured to sense a location change and a direction change of the vehicle 100 based on an inertial acceleration. In an embodiment, the IMU 122 may be a combination of an accelerometer and a gyroscope. The radar 123 may sense an object in the ambient environment of the vehicle 100 through a radio signal. In some embodiments, in addition to sensing the object, the radar 123 may be configured to sense a speed and/or an advancing direction of the object. The laser rangefinder 124 may sense, through a laser, an object in the environment of the vehicle 100. In some embodiments, the laser rangefinder 124 may include one or more laser sources, a laser scanner, one or more detectors, and another system component. The camera 125 may be configured to capture a plurality of images of the ambient environment of the vehicle 100. For example, the camera 125 may be a static camera or a video camera.

The control system 130 controls operations of the vehicle 100 and components of the vehicle 100. The control system 130 may include various elements, such as a steering system 131, a throttle 132, a braking unit 133, a computer vision system 134, a route control system 135, and an obstacle avoidance system 136. For example, the steering system 131 may be operated to adjust a forward direction of the vehicle 100. For example, the steering system may be a steering wheel system. The throttle 132 may be configured to control an operation speed of the engine 111 and further control a speed of the vehicle 100. The braking unit 133 may be configured to control the vehicle 100 to decelerate; and the braking unit 133 may use friction to slow down the wheel 114. In another embodiment, the braking unit 133 may convert kinetic energy of the wheel 114 into a current. The braking unit 133 may alternatively reduce a rotation speed of the wheel 114 in another form, to control the speed of the vehicle 100.

The computer vision system 134 may be operated to process and analyze an image captured by the camera 125, to recognize the object and/or a feature in the ambient environment of the vehicle 100. The object and/or the feature may include one or more of a traffic signal, a road boundary, an obstacle, and a parking space boundary. The computer vision system 134 may use an object recognition algorithm, a structure from motion (SFM) algorithm, video tracking, or another computer vision technology. In some embodiments, the computer vision system 134 may be configured to draw a map for an environment (for example, draw a local map of the parking lot), track an object, estimate a speed of the object, and the like. The computer vision system 134 may draw the map for the environment according to, but not limited to, an algorithm such as a synchronous localization and mapping (SLAM) algorithm.

The route control system 135 may be configured to determine a traveling route of the vehicle 100. In some embodiments, the route control system 135 may determine the traveling route for the vehicle 100 with reference to the map that is of the parking lot and that is delivered by the server 200 and an available parking space autonomously selected by the vehicle 100 (or an available parking space selected by the user). The obstacle avoidance system 136 may be configured to recognize, evaluate, and avoid or bypass, in another manner, a potential obstacle in the environment of the vehicle 100. In some instances, the control system 130 may add or alternatively include components in addition to those shown and described. Alternatively, some of the foregoing shown components may be reduced.

The vehicle 100 may interact with an external sensor, another vehicle, another computer system, or a user by using the peripheral device 140. The peripheral device 140 may include a wireless communication system 141, a vehicle-mounted computer 142, a microphone 143, and/or a speaker 144. In some embodiments, the peripheral device 140 may provide means for the vehicle 100 to interact with the user interface 170. For example, the vehicle-mounted computer 142 may provide information for the user of the vehicle 100, for example, display the map of the parking lot and/or the available parking space that are/is received from the server 200. The user interface 116 may be further used to operate the vehicle-mounted computer 142 to receive an input of the user, for example, receive the available parking space selected by the user. The vehicle-mounted computer 142 may be operated through a touchscreen. In another case, the peripheral device 140 may provide means for the vehicle 100 to communicate with another device located in the vehicle. For example, the microphone 143 may receive audio (for example, a voice command or another audio input) from the user of the vehicle 100. Similarly, the speaker 144 may output the audio to the user of the vehicle 100. The wireless communication system 141 may wirelessly communicate with one or more devices directly or through a communication network, for example, communicate with the server 200.

The power supply 160 may provide power to various components of the vehicle 100. In some embodiments, the power supply 160 may be a rechargeable lithium-ion or lead-acid battery. One or more battery groups of such a battery may be configured as a power supply to supply power to the various components of the vehicle 100. In some embodiments, the power supply 160 and the energy source 113 may be implemented together, for example, as manners in some pure electric vehicles.

Some or all of functions of the vehicle 100 may be controlled by the computer system 150. The computer system 150 may include at least one processor 151, and the processor 151 executes instructions 153 stored in, for example, a non-transient computer-readable medium in a memory 152. The computer system 150 may alternatively be a plurality of computing devices that control an individual component or a subsystem of the vehicle 100 in a distributed manner. For example, the processor 151 may be any processor, such as a commercially available CPU. Optionally, the processor may be a dedicated device like an ASIC or another hardware-based processor. Although FIG. 2 functionally illustrates a processor, a memory, and another element of a computer in a same block, a person of ordinary skill in the art should understand that the processor, the computer, or the memory may actually include a plurality of processors, computers, or memories that may or may not be stored in a same physical housing. For example, the memory may be a hard disk drive or another storage medium located in a housing different from the housing of the computer. Therefore, a reference to the processor or the computer will be understood as including a reference to a set of processors, computers, or memories that may or may not operate in parallel. Different from using a single processor to perform the steps described herein, some components such as a steering component and a deceleration component each may include a respective processor. The processor performs only computation related to a component-specific function. In various aspects described herein, the processor may be located far away from the vehicle and perform wireless communication with the vehicle. In another aspect, some of processes described herein are performed on a processor disposed inside the vehicle, while others are performed by a remote processor. The processes include necessary steps for performing a single operation. In some embodiments, the memory 152 may include the instructions 153 (for example, program logic), and the instructions 153 may be executed by the processor 151 to perform various functions of the vehicle 100, including the functions described above. The memory 152 may also include an additional instruction, for example, including an instruction used to send data to, receive data from, interact with, and/or control one or more of the travel system 110, the sensing system 120, the control system 130, and the peripheral device 140. For example, in addition to the instructions 153, the memory 152 may further store data, such as a road map, route information, a location, a direction, a speed, and other similar vehicle data of the vehicle, and other information. Such information may be used by the vehicle 100 and the computer system 150 when the vehicle 100 operates in an autonomous mode, a semi-autonomous mode, and/or a manual mode.

The user interface 170 may be configured to provide information for or receive information from the user of the vehicle 100. Optionally, the user interface 170 may include one or more input/output devices in a set of peripheral devices 140, such as the wireless communication system 141, the vehicle-mounted computer 142, the microphone 143, and the speaker 144.

In some embodiments, the computer system 150 may control the functions of the vehicle 100 based on inputs received from various subsystems (for example, the travel system 110, the sensing system 120, and the control system 130) and from the user interface 170. For example, the computer system 150 may use an input from the control system 130 to control the braking unit 133 to avoid an obstacle detected by the sensing system 120 and the obstacle avoidance system 136. In some embodiments, the computer system 150 may be operated to provide control over many aspects of the vehicle 100 and the subsystems of the vehicle 100. Optionally, one or more of the foregoing components may be separately mounted from or associated with the vehicle 100. For example, the memory 152 may be partially or totally separated from the vehicle 100. The foregoing components may be communicatively coupled together in a wired and/or wireless manner.

Optionally, the vehicle 100 may be an autonomous vehicle traveling on a road, and may recognize an object in the ambient environment of the vehicle to determine adjustment to a current speed. The object may be another vehicle, a traffic control device, or another type of object. In some examples, each recognized object may be considered independently, and characteristics of each object, such as a current speed of the object, an acceleration of the object, and a spacing between the object and the vehicle, may be used to determine a speed to be adjusted by the autonomous vehicle. Optionally, the vehicle 100 or a computing device (for example, the computer system 150, the computer vision system 134, or the memory 152 in FIG. 1) associated with the vehicle 100 may predict a behavior of the recognized object based on the characteristics of the recognized object and a status (for example, traffic, rain, or ice on the road) of the ambient environment. Optionally, recognized objects all depend on behaviors of each other. Therefore, all the recognized objects may be considered together to predict a behavior of a single recognized object. The vehicle 100 can adjust the speed of the vehicle 100 based on the predicted behavior of the recognized object. In other words, the autonomous vehicle can determine, based on the predicted behavior of the object, that the vehicle needs to be adjusted to a stable status (for example, an adjustment operation may include acceleration, deceleration, or stop). In this process, another factor, for example, a transverse location of the vehicle 100 on the road on which the vehicle 100 travels, a curvature of the road, or proximity between static and dynamic objects may also be considered, to determine the speed of the vehicle 100. In addition to providing an instruction for adjusting the speed of the autonomous vehicle, the computer system 150 may provide an instruction for modifying a steering angle of the vehicle 100, so that the autonomous vehicle can follow a given track and/or maintain a safe horizontal distance and a safe vertical distance from an object (for example, a car on a neighboring lane of the road) near the autonomous vehicle. The vehicle 100 may be a car, a truck, a motorcycle, a bus, a boat, a plane, a helicopter, a lawn mower, a recreational vehicle, an amusement park vehicle, a construction device, a trolley, a golf cart, a train, a handcart, or the like. This is not specifically limited in embodiments of this disclosure.

It may be understood that the structure illustrated in embodiments of this disclosure does not constitute a specific limitation on the vehicle 100. In some other embodiments of this disclosure, the vehicle 100 may include more or fewer components than those shown in the figure, or combine some components, or divide some components, or have different component arrangements. The components shown in the figure may be implemented by hardware, software, or a combination of software and hardware.

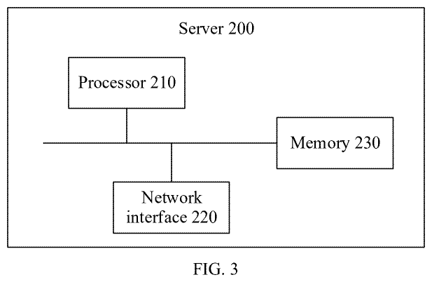

For example, FIG. 3 is a diagram of a hardware structure of a server according to an embodiment of this disclosure. As shown in FIG. 3, the server 200 includes a processor 210, a network interface 220, and a memory 230. The processor 210, the network interface 220, and the memory 230 may be connected through a bus or in another manner. In embodiments, the processor 210 (or referred to as a central processing unit (CPU)) is a computing core and a control core of the server 200. In some embodiments, the processor 210 may construct the complete map of the parking lot based on data received from the vehicle 100 and/or another vehicle, recognize the available parking space in the parking lot, and identify the available parking space in the map of the parking lot. Optionally, the network interface 220 may include a standard wired interface, a standard wireless interface (for example, a WIFI interface or a mobile communication interface), and is controlled by the processor 210 to receive and send data. For example, the network interface 220 receives, from a network, data sent by the vehicle 100 or the other vehicle, or sends the map of the parking lot, the available parking space in the parking lot, and the like to the vehicle 100 or the other vehicle. The memory 230 is a memory device of the server, and is configured to store a program and data, for example, store the map of the parking lot. It may be understood that the memory 230 may be a high-speed RAM memory, or may be a non-volatile memory, for example, at least one magnetic disk memory. Optionally, the memory 230 may further be at least one storage apparatus that is away from the foregoing processor 210. The memory 230 provides a storage space. The storage space stores an operating system and executable program code of the server, and may include operating systems such as, for example, but not limited to a WINDOWS system a LINUX system, HARMONYOS, or the like. This is not limited herein. For example, the server 200 may be but is not limited to a cloud server, a bare metal server, a virtual server, an edge server, or the like.

The following describes a parking method provided in an embodiment of this disclosure.

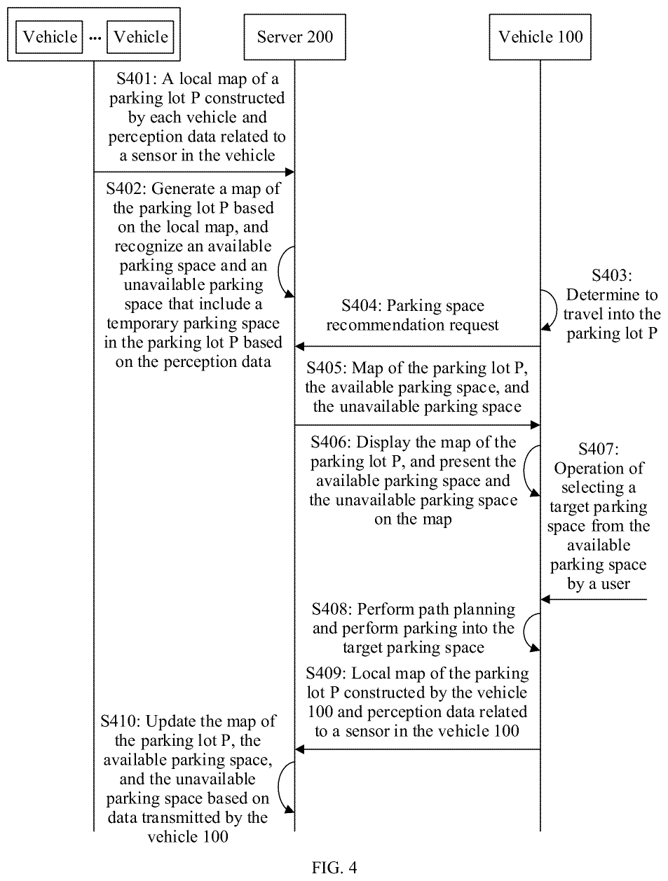

For example, FIG. 4 is a schematic flowchart of a parking method according to an embodiment of this disclosure. As shown in FIG. 4, the parking method may include the following steps.
S401: The server 200 receives a local map of a parking lot P constructed by at least one vehicle and perception data (for example, environment information of the parking lot P) related to a sensor in the vehicle.

In this embodiment, when local laws and regulations are observed, and a user authorizes and enables vehicle information sharing, after the user drives the vehicle into the parking lot P, the vehicle may upload, to the server 200, the local map of the parking lot P constructed by the vehicle and data (for example, the perception data) perceived by the sensor in the vehicle. The vehicle may determine an entrance of the parking lot based on an image captured by a camera or the like configured on the vehicle, and determine, based on GPS data on the vehicle, whether the vehicle arrives at the parking lot P. In some embodiments, the server 200 may further receive environment information of the parking lot P collected and a map constructed by a cruising device deployed in the parking lot P. In an example, the server 200 may further receive environment information of the parking lot P collected by an image capturing device deployed in the parking lot P, and/or receive a preconfigured map of the parking lot P.
S402: The server 200 generates a map of the parking lot P based on the received local map of the parking lot P, and recognizes an available parking space and an unavailable parking space that include a temporary parking space in the parking lot P based on the received perception data related to the sensor in the vehicle.

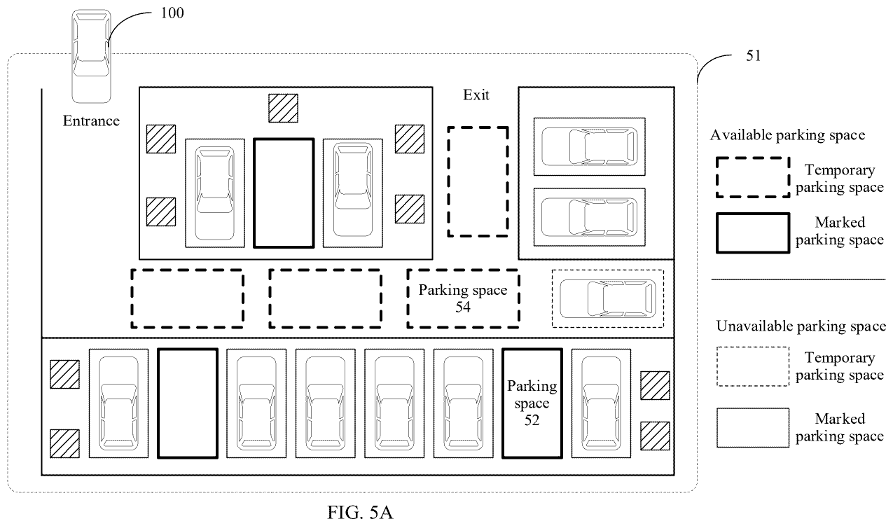

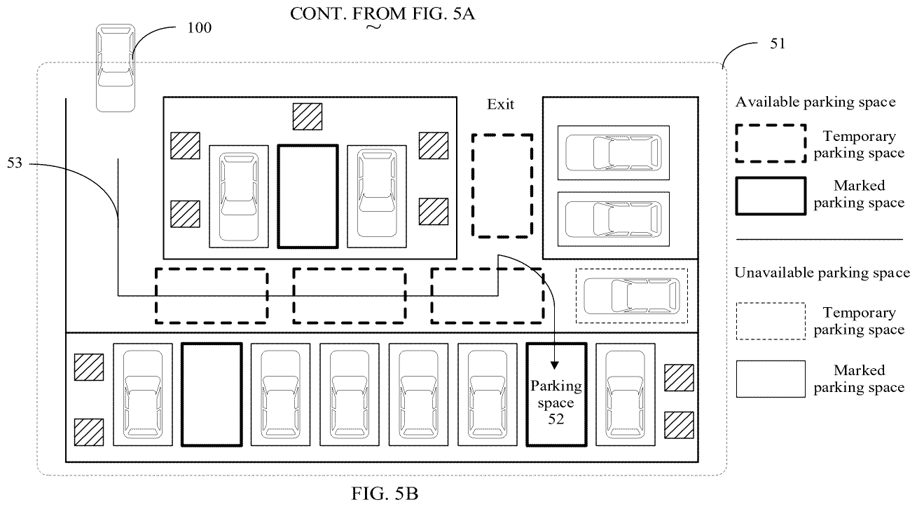

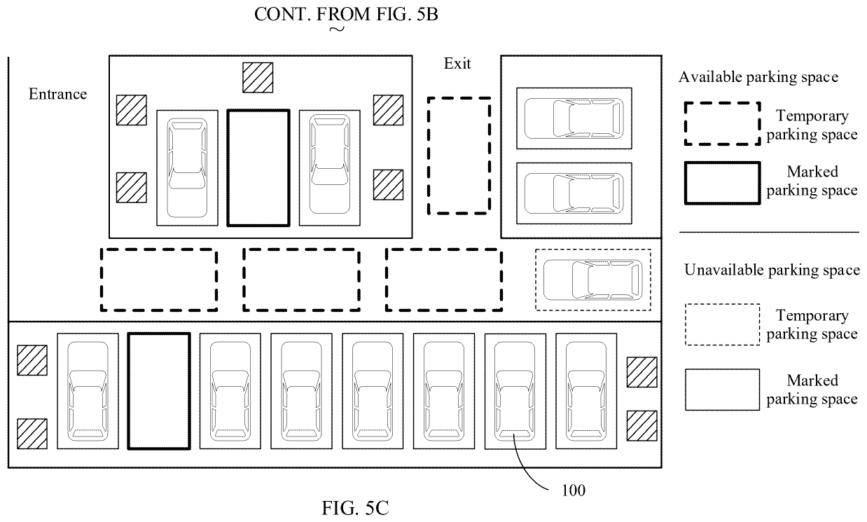

In embodiments, the server 200 may fuse local maps of the parking lot P transmitted by different vehicles according to a neural network algorithm, an image relocalization algorithm, an iterative closest point (ICP) algorithm, or the like, to generate the map of the parking lot P. In addition, the server 200 may further process, through a neural network or the like, the perception data that is related to the sensor in the vehicle and that is received by the server 200, to recognize the available parking space and the unavailable parking space that include the temporary parking space in the parking lot P. For example, the perception data related to the sensor in the vehicle may include data collected by a lidar and the camera in the vehicle. In this case, the server 200 may generate a point cloud map based on the data collected by the lidar, and perform semantic extraction on the point cloud map, to recognize parking information in the parking lot P, for example, a place in which a vehicle is parked. In addition, the server 200 may further perform semantic extraction on the image, to recognize a marked parking space in the parking lot, recognize a temporary parking area, and divide the temporary parking area into temporary parking spaces. For example, the server 200 may use a road in the parking lot P as a temporary parking area, and then divide the road with a fixed size, to obtain temporary parking spaces. Further, the server 200 may recognize the available parking space and the unavailable parking space in the parking lot P by combining the point cloud map with information recognized from the image. Both the available parking space and the unavailable parking space include a marked parking space and/or a temporary parking space. The unavailable parking space may be understood as an occupied parking space. In some embodiments, when the perception data related to the sensor in the vehicle does not include the data collected by the lidar, the server 200 may alternatively perform depth estimation on the image captured by the camera, and generate a point cloud map.
It should be noted that S401 and S402 are not necessary steps of the method. In other words, S401 and S402 do not need to be performed each time in execution of the method.
S403: The vehicle 100 determines to travel into the parking lot P, where the vehicle 100 may determine the entrance of the parking lot based on the image captured by the camera or the like configured on the vehicle, and determine, based on the GPS data on the vehicle, whether the vehicle arrives at the parking lot P.
S404: The vehicle 100 sends a parking space recommendation request to the server 200, where when the vehicle 100 travels into the parking lot P, the vehicle 100 may send the parking space recommendation request to the server 200.
S405: The server 200 sends the map of the parking lot P, the available parking space, and the unavailable parking space to the vehicle 100.
S406: The vehicle 100 displays the map of the parking lot P, and presents the available parking space and the unavailable parking space on the map. After receiving the map of the parking lot P, the available parking space, and the unavailable parking space from the server 200, the vehicle 100 may display the map of the parking lot P by using a display or the like that matches the vehicle 100, and present the available parking space and the unavailable parking space on the map. For example, an interface shown in an area 51 in FIG. 5A may be displayed on the display of the vehicle 100 (for example, the vehicle 100 may alternatively not be displayed in the area 51, and this is not limited herein). In addition, when displaying the available parking space and the unavailable parking space, the vehicle 100 may further distinguish between the available parking space and the unavailable parking space, so that the user can intuitively learn which is the available parking space and which is the unavailable parking space. In other words, the available parking space and the unavailable parking space may be displayed on the map with different identifiers. For example, still refer to FIG. 5A to FIG. 5C. In the area 51, the available parking space (for example, a parking space 54) may be identified by using a bold line, and the unavailable parking space (for example, a parking space 52) may be identified by using a non-bold line. In an example, another identification manner, for example, different colors, may be used. This is not limited herein. In addition, a vehicle may also be displayed on the unavailable parking space, so that the user can more intuitively learn where a vehicle is parked and where no vehicle is parked. In addition, still refer to FIG. 5A to FIG. 5C. It can be intuitively seen from FIG. 5A to FIG. 5C that the temporary parking space is obtained through division on the road (for example, an area other than a marked parking space) inside the parking lot.
S407: The vehicle 100 receives an operation of selecting a target parking space from the available parking space by the user. The user may select a desired parking space (for example, the target parking space) from an interface displayed by the vehicle 100. After the user completes the selection, the vehicle 100 may receive the operation of selecting the target parking space.
S408: The vehicle 100 performs path planning and is parked into the target parking space. After the user completes the parking space selection, the vehicle 100 may perform path planning. Path planning is planning a path for parking into the target parking space. In addition, the vehicle 100 may also display the planned path, so that the user can learn how to drive into the target parking space. For example, still refer to FIG. 5A to FIG. 5C. In FIG. 5A, after the user selects the parking space 52, the vehicle 100 may display an interface shown in FIG. 5B. In FIG. 5B, a line 53 is a planned path for driving into the parking space 52. After completing path planning, the vehicle 100 may be parked into the target parking space by using an auto parking system configured on the vehicle 100. It should be understood that the user may alternatively participate in a parking process. This may be specifically determined based on an actual situation, and is not limited herein. In addition, when the vehicle 100 is not configured with the auto parking system, the user may alternatively park the vehicle 100 into the target parking space by the user. For example, still refer to FIG. 5A to FIG. 5C. After the vehicle 100 is parked into the parking space 52, the vehicle 100 may display an interface shown in FIG. 5C.
S409: After the vehicle 100 is parked into the target parking space, the vehicle 100 uploads, to the server 200, a local map of the parking lot P constructed by the vehicle 100 and perception data related to a sensor in the vehicle 100.
S410: The server 200 updates the map of the parking lot P, the available parking space, and the unavailable parking space based on data uploaded by the vehicle 100.

In embodiments, after receiving the data uploaded by the vehicle 100, the server 200 may update the map of the parking lot P based on the local map of the parking lot P uploaded by the vehicle 100, to improve the map of the parking lot P. For details, refer to the descriptions in S402. Details are not described herein again. In addition, the server 200 may further update the available parking space and the unavailable parking space in the parking lot P based on the perception data uploaded by the vehicle 100, to update these parking spaces in time, so that a vehicle that subsequently enters the parking lot P can obtain latest information about the available parking space and the unavailable parking space. For details, refer to the descriptions in S402. Details are not described herein again. For example, still refer to FIG. 5A to FIG. 5C. After the vehicle 100 is parked into the parking space 52, when another vehicle enters the parking lot P, the vehicle may display an interface shown in FIG. 5C. In an example, an identifier of the vehicle that newly enters the parking lot P may be displayed at the same time.

In this way, through information sharing between vehicles, an available parking space and an unavailable parking space received by the vehicles can be kept in a latest state. In addition, the temporary parking space in the parking lot is divided, so that a quantity of available parking spaces in the parking lot can be increased, to improve utilization of parking spaces of the parking lot.

In some embodiments, after available parking spaces are recommended to the vehicle 100, the user may randomly select a parking space affecting a vehicle that subsequently enters the parking lot or needs to leave the parking lot. For example, still refer to FIG. 5A to FIG. 5C. In FIG. 5A, the available parking space includes the parking space 52 and the parking space 54. If the user selects to park the vehicle 100 in the parking space 54, most vehicles cannot leave the parking lot. Therefore, to minimize such impact, the server 200 may further grade available parking spaces, and during grading, set a priority of a parking space that affects another vehicle to be low and a priority of a parking space that does not affect another vehicle to be high. In this way, the user may perform selection based on priorities of the available parking spaces. For example, still refer to FIG. 5A. In this case, a priority of the parking space 52 is higher than a priority of the parking space 54. For example, to help the user intuitively learn priorities of different parking spaces, when displaying the available parking spaces, the vehicle 100 may further identify, with different identifiers, parking spaces with different parking priorities. For example, a parking space with a highest priority may be identified by using a green identifier, a parking space with a lowest priority may be identified by using a red identifier, and the like. For example, because parking in a marked parking space has small impact on another vehicle, a parking priority of the marked parking space in the available parking spaces may be higher than a parking priority of a temporary parking space. In addition, when there is a plurality of marked parking spaces in the available parking spaces, the plurality of marked parking spaces may be graded, and in this case, different marked parking spaces may also have different parking priorities. When there is a plurality of temporary parking spaces in the available parking spaces, the plurality of temporary parking spaces may be graded, and in this case, different temporary parking spaces may also have different parking priorities. However, when displaying parking spaces in the available parking spaces on the map, the vehicle 100 may display parking spaces with different parking priorities by using different identifiers, and the different identifiers may indicate different parking priorities.

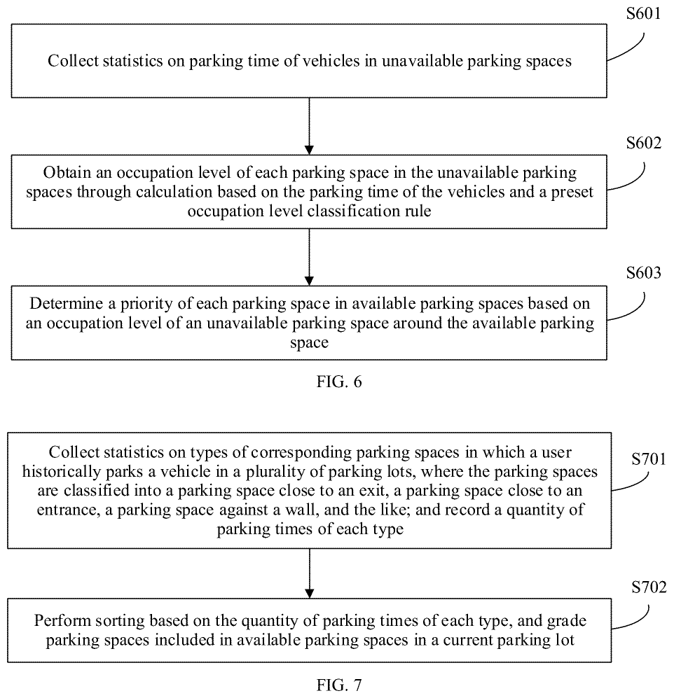

In a possible implementation, when grading the available parking spaces in the parking lot, the server 200 may grade the available parking spaces based on an occupation level of the unavailable parking space. Specifically, as shown in FIG. 6, in S601, after the vehicle is parked into a parking space, the server 200 may start to record parking time of the vehicle, to collect statistics on parking time of vehicles in unavailable parking spaces. In S602, the server 200 may obtain an occupation level of each parking space in the unavailable parking spaces through calculation based on the parking time of the vehicles and a preset occupation level classification rule. For example, the occupation level classification rule may be as follows. When parking duration is greater than or equal to seven days, an occupation level is high; when parking duration is greater than or equal to three days and less than seven days, an occupation level is medium; or when parking duration is less than three days, an occupation level is low. In S603, the server 200 determines a priority (for example, a parking priority) of each parking space in the available parking spaces based on an occupation level of an unavailable parking space around the available parking space. For example, parking in the marked parking space usually does not affect another vehicle. Therefore, a priority of the marked parking space in the available parking spaces may be set to high. However, for the temporary parking space in the available parking spaces, a quantity of parking spaces with different occupation levels next to the temporary parking space may be counted, and then a priority of the temporary parking space is set based on the counted quantity of parking spaces with the different occupation levels. For example, for a temporary parking space in the available parking spaces, when a quantity of parking spaces with a high occupation level next to the parking space is greater than or equal to 2, and a quantity of parking spaces with a medium occupation level and a quantity of parking spaces with a low occupation level are both less than or equal to 1, it may be determined that a priority of the temporary parking space is medium; or when a quantity of parking spaces with a high occupation level next to the parking space is less than or equal to 1, a quantity of parking spaces with a medium occupation level is greater than 1, and a quantity of parking spaces with a low occupation level is greater than 2, it may be determined that a priority of the temporary parking space is low. In addition, when a priority of a parking space included in the available parking spaces is determined, a factor like a location of the parking space may be further considered. For example, for a temporary parking space that may affect passing of another vehicle, a priority of the temporary parking space may be set to low. For example, that a parking space in the available parking spaces has a high priority may be understood as that the parking space is preferentially selected.

In another possible implementation, when grading available parking spaces in the parking lot, the server 200 may grade the available parking spaces based on a historical parking habit of the user. Specifically, as shown in FIG. 7, in S701, statistics are collected on types of corresponding parking spaces in which the user historically parks a vehicle in a plurality of parking lots, the parking spaces are classified into a parking space close to an exit, a parking space close to an entrance, a parking space against a wall, and the like, and a quantity of parking times of each type is recorded. S702: Perform sorting based on the quantity of parking times of each type, and grade parking spaces included in the available parking spaces in the current parking lot. In addition, statistics may also be collected on corresponding parking space locations in which the user historically parks in the current parking lot, and a quantity of parking times at each location is recorded. Then, the parking spaces included in the available parking spaces in the current parking lot are graded based on quantities of parking times at different locations in the current parking lot.

In another possible implementation, when grading the available parking spaces in the parking lot, the server 200 may grade the available parking spaces based on an occupation level of an unavailable parking space and a historical parking habit of the user. In other words, the foregoing two manners are combined to grade the available parking spaces. In this case, during grading, different weights may be assigned to different parking spaces in the current parking lot based on the historical parking habit of the user. For example, a high weight may be assigned to a parking space that matches a parking location or type frequently used by the user, and a low weight may be assigned to a parking space that does not match a parking location or type frequently used by the user. Finally, priorities of the available parking spaces that are separately classified based on the occupation level of unavailable parking space are adjusted based on the weights of the different parking spaces. For example, a priority of a parking space may be scored, and a scoring formula is:

$${U}_{level} = 1 - ( \frac{0.1}{1 + {N}_{OH}} + \frac{0.3}{1 + {N}_{OM}} + \frac{0.6}{1 + {N}_{OL}} ) \qquad ( Formula 1 )$$

Here, Uₗₑᵥₑₗ is a priority score, N_{ON} is a quantity of parking spaces whose occupation levels are high and that are next to the to-be-graded parking space, Nom is a quantity of parking spaces whose occupation levels are medium and that are next to the to-be-graded parking space, and N_{OL} is a quantity of parking spaces whose occupation levels are low and that are next to the to-be-graded parking space.

After the priority score of the to-be-graded parking space is obtained through calculation, the score is multiplied by a weight of the to-be-graded parking space, to obtain a final score of the to-be-graded parking space. Finally, sorting is performed based on scores of all available parking spaces, and one or more available parking spaces that are ranked in the front are selected and recommended to the user. In an example, all available parking spaces may alternatively be graded based on the scores. For example, priorities of first five available parking spaces whose scores are ranked in the front are high, priorities of sixth to tenth available parking spaces are medium, priorities of eleventh to fifteenth available parking spaces are low, and the like.

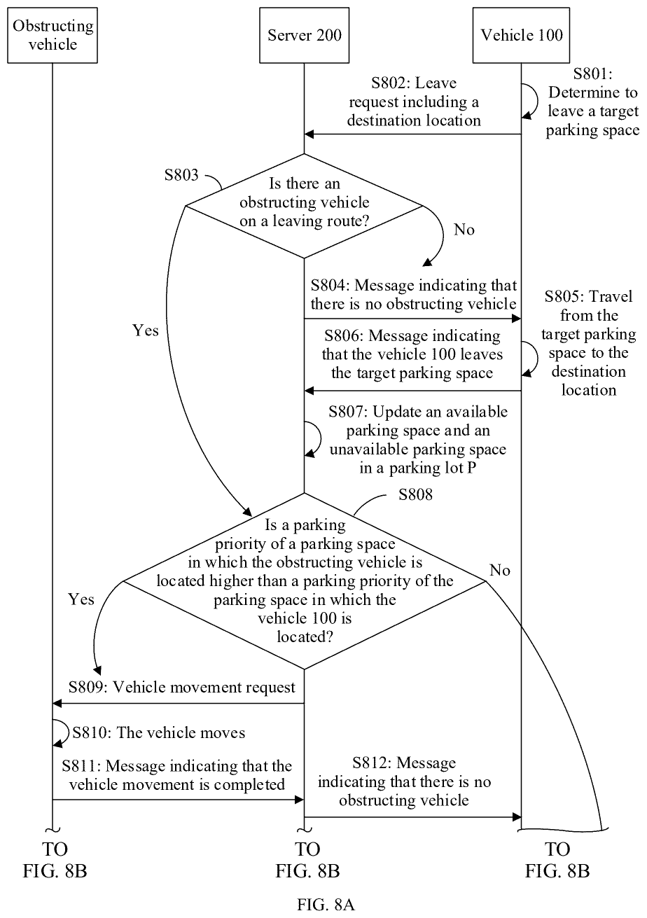

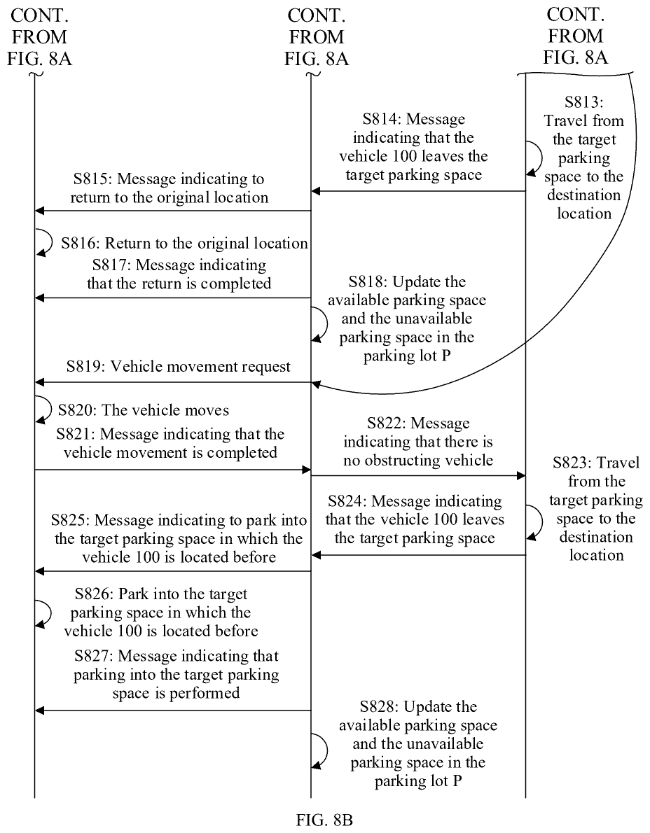

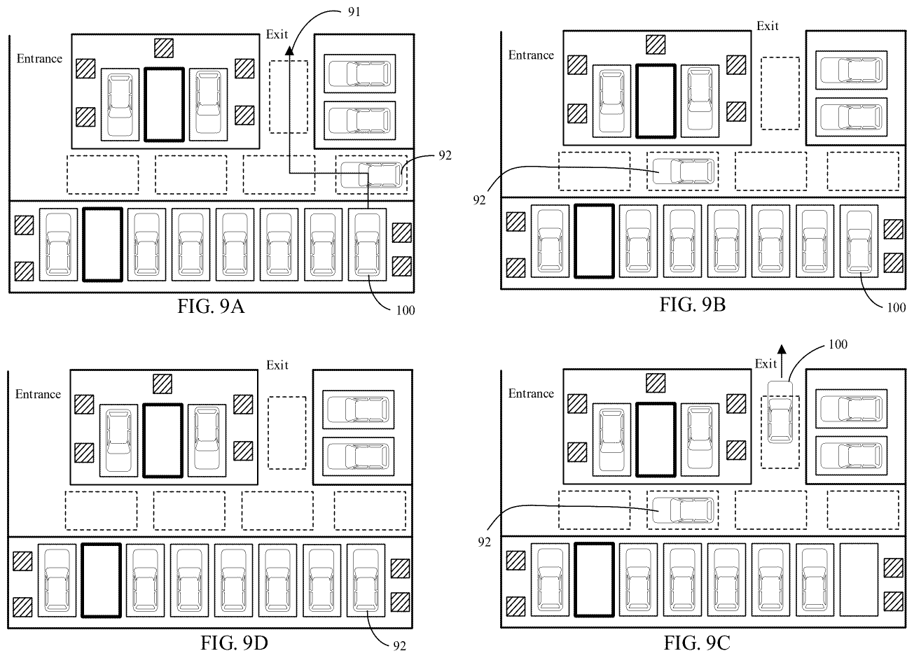

In some embodiments, after the user parks the vehicle 100 into a parking space in the parking lot P, when the vehicle 100 needs to leave the current parking space of the vehicle 100, for example, needs to leave the parking lot P or travel to another location in the parking lot P, the vehicle 100 may be pulled out based on a vehicle pulling-out method shown in FIG. 8A and FIG. 8B. Refer to FIG. 8A and FIG. 8B. FIG. 8A and FIG. 8B is a diagram of steps of the vehicle pulling-out method according to an embodiment of this disclosure. As shown in FIG. 8A and FIG. 8B, the vehicle pulling-out method may include the following steps.
S801: The vehicle 100 determines that the vehicle 100 needs to leave a target parking space in which the vehicle 100 is parked. The user may deliver a leave instruction to the vehicle 100 by using a device like a mobile phone of the user, or may perform a leave operation on the vehicle 100. For example, after the user starts the vehicle 100, the vehicle 100 may display, on the display of the vehicle 100, information that needs to be confirmed by the user whether to leave. After the user confirms the information, the vehicle 100 may confirm that the vehicle 100 needs to leave the target parking space. In addition, the user may further select a destination location to which the vehicle 100 needs to travel, for example, travel to another location in the parking lot or travel out of the parking lot.
S802: The vehicle 100 sends a leave request including the destination location to the server 200. When the user drives away from the parking lot, the destination location may be but is not limited to an exit of the parking lot.
S803: The server 200 determines whether there is an obstructing vehicle on a leaving route from the target parking space to the destination location. The server 200 may autonomously plan a leaving route for the vehicle 100. For example, as shown in FIG. 9A, when the vehicle 100 needs to leave the parking lot, the leaving route planned by the server 200 may be a route 91. After planning the leaving route, the server 200 may determine, based on a parking location that is of each vehicle in the parking lot and that is recorded by the server 200, whether there is an obstructing vehicle on the leaving route. For example, still refer to FIG. 9A. There is an obstructing vehicle 92 on the leaving route 91. When there is no obstructing vehicle on the leaving route, S804 to S807 may be performed. Alternatively, when there is an obstructing vehicle on the leaving route, S808 to S827 may be performed.
S804: The server 200 sends, to the vehicle 100, a message indicating that there is no obstructing vehicle. In addition, the server 200 may further send the leaving route to the vehicle 100.
S805: The vehicle 100 travels from the target parking space to the destination location. The vehicle 100 may plan a route to the destination location by vehicle. In addition, after the server 200 sends the leaving route to the vehicle 100, the vehicle 100 may alternatively travel along the leaving route planned by the server 200 for the vehicle 100. This is not limited herein.
S806: After leaving the target parking space, the vehicle 100 may send, to the server 200, a message indicating that the vehicle 100 leaves the target parking space.
S807: The server 200 updates an available parking space and an unavailable parking space in the parking lot P. For example, the server 200 may update the target parking space from an unavailable parking space into an available parking space.
S808: The server 200 determines whether a parking priority of a parking space in which the obstructing vehicle is located is higher than a parking priority of the parking space in which the vehicle 100 is located. If the parking priority of the parking space in which the obstructing vehicle is located is higher than the parking priority of the parking space in which the vehicle 100 is located, S809 to S818 may be performed; otherwise, S819 to S828 may be performed. When both the parking space in which the obstructing vehicle is located and the parking space in which the vehicle 100 is located are marked parking spaces, it may be considered that parking priorities of the two parking spaces are the same. In addition, if the two parking spaces are of a Parent-and-child parking space type, it is considered that a parking priority of a parking space on a side close to a road is low. When one of the two parking spaces is a marked parking space, and the other is a temporary parking space, it may be considered that a parking priority of the temporary parking space is lower than a parking priority of the marked parking space. When both of the two parking spaces are temporary parking spaces, a parking priority of a parking space that can greatly affect another vehicle is low. It should be noted that, in S809 to S818, the obstructing vehicle first leaves an original location and then returns to the original location. However, in S819 to S828, the obstructing vehicle first leaves an original location and then is parked at a location at which the vehicle 100 is previously located. In this manner, parking priorities of parking spaces in which the obstructing vehicle is subsequently located are all high, and a risk of affecting another vehicle is reduced.
S809: The server 200 sends a vehicle movement request to the obstructing vehicle. For example, the server 200 may plan a location for the obstructing vehicle by the server, and indicate the obstructing vehicle to travel to the location.
S810: The obstructing vehicle moves away. The obstructing vehicle may plan a location to travel to by the obstructing vehicle, or may travel to the location planned by the server 200 for the obstructing vehicle, for example, a marked parking space.
S811: After completing the vehicle movement, the obstructing vehicle may send, to the server 200, a message indicating that the vehicle movement is completed.
S812: After the obstructing vehicle leaves, the server 200 may send, to the vehicle 100, a message indicating that there is no obstructing vehicle.
S813: The vehicle 100 travels from the target parking space to the destination location.
S814: After leaving the target parking space, the vehicle 100 may send, to the server 200, a message indicating that the vehicle 100 leaves the target parking space.
S815: The server 200 sends, to the obstructing vehicle, a message indicating to return to the original location.
S816: The obstructing vehicle returns to the original location.
S817: After returning to the original location, the obstructing vehicle sends, to the server 200, a message indicating that the obstructing vehicle returns to the original location.
S818: The server 200 updates the available parking space and the unavailable parking space in the parking lot P.

It should be noted that, in S809 to S818, when the parking request sent by the server 200 to the obstructing vehicle in S809 includes a latest parking space planned by the server 200 for the obstructing vehicle, after the obstructing vehicle travels into the parking space, the obstructing vehicle may no longer return to the original location of the obstructing vehicle, that is, the obstructing vehicle remains in the latest parking space into which the obstructing vehicle travels. In this case, S815, S816, and S817 may not need to be performed. In other words, in a vehicle movement process, the server 200 may recommend a new parking space to the obstructing vehicle by the server, without making the obstructing vehicle return to the original location. In an example, when the obstructing vehicle travels into the new parking space and does not return to the original location, the server 200 or the obstructing vehicle may notify a user of this vehicle movement behavior, and notify the user of the latest location of the obstructing vehicle, so that the user can learn of the latest location of the vehicle in time.
S819: The server 200 sends a vehicle movement request to the obstructing vehicle.
S820: The obstructing vehicle moves away. For example, still refer to FIG. 9A. In FIG. 9A, the vehicle 92 is located on the route 91 for the vehicle 100 to leave the parking lot. Therefore, the vehicle 92 is an obstructing vehicle. After receiving the vehicle movement request sent by the server 200, the vehicle 92 may perform a vehicle movement operation. For example, the vehicle 92 may move to a location of the vehicle 92 shown in FIG. 9B.
S821: After completing the vehicle movement, the obstructing vehicle may send, to the server 200, a message indicating that the vehicle movement is completed.
S822: After the obstructing vehicle leaves, the server 200 may send, to the vehicle 100, a message indicating that there is no obstructing vehicle.
S823: The vehicle 100 travels from the target parking space to the destination location.
S824: After leaving the target parking space, the vehicle 100 may send, to the server 200, a message indicating that the vehicle 100 leaves the target parking space. For example, still refer to FIG. 9B. In FIG. 9B, the vehicle 92 no longer blocks the vehicle 100. Therefore, the vehicle 100 can leave. After the vehicle 100 leaves (for example, travels away to an exit location shown in FIG. 9C), the vehicle 100 may send, to the server, a message indicating that the vehicle 100 leaves.
S825: The server 200 sends, to the obstructing vehicle, a message indicating to park into the target parking space in which the vehicle 100 is located before.
S826: The obstructing vehicle parks into the target parking space. For example, still refer to FIG. 9. In FIG. 9C, the vehicle 100 leaves the parking space. Therefore, as shown in FIG. 9D, the vehicle 92 may travel into the parking space in which the vehicle 100 is located before.
S827: After parking into the target parking space, the obstructing vehicle sends, to the server 200, a message indicating that the obstructing vehicle is parked into the target parking space.
S828: The server 200 updates the available parking space and the unavailable parking space in the parking lot P.

In this way, the vehicle is pulled out in the foregoing vehicle pulling-out manner. In addition, after a location of the obstructing vehicle changes, the obstructing vehicle may independently notify the user of this vehicle movement behavior and a latest location. In an example, the server 200 may alternatively notify the user of this vehicle movement behavior and a latest location of the obstructing vehicle. In addition, if the obstructing vehicle does not enable free vehicle movement permission, before S809, the server 200 may send a vehicle movement request to the user related to the obstructing vehicle, and perform subsequent steps after the user grants permission. Because this vehicle movement notification is independently delivered by the server, contact between users can be avoided, to reduce a conflict occurrence rate.

In some embodiments, the server 200 may update parking space information in the parking lot in real time or periodically (for example, every 10 minutes). In this way, it can be ensured that the unavailable parking space and the available parking space in the parking lot are in a latest state, to facilitate parking space management in the parking lot. After updating the parking space information in the parking lot, the server 200 may recalculate parking priorities of all available parking spaces, and sort the available parking spaces based on the parking priorities. In addition, the server 200 may alternatively calculate parking priorities of unavailable parking spaces when no vehicle is parked in the unavailable parking spaces. When determining, through calculation, that a parking priority of an available parking space is higher than a parking priority of an unavailable parking space (for example, a parking priority of an original parking solution), the server 200 may send a vehicle movement request to a vehicle parked in the unavailable parking space, to request the vehicle to be parked in the available parking space with a highest parking priority. For example, when the unavailable parking space is a temporary parking space, and the available parking space is a marked parking space, the vehicle may be parked into the marked parking space from the temporary parking space. After the vehicle is parked in the new parking space, the server 200 may send notification information to a terminal device used by a user, so that the user can learn of parking space change information in time.

In addition, when determining, through calculation, that a parking priority of an available parking space is higher than a parking priority of an unavailable parking space, the server 200 may alternatively first send confirmation information to a terminal device used by a user. After receiving the confirmation information, the user may determine whether to park a vehicle into the new parking space. After the user determines to park the vehicle into the new parking space, the server 200 may send a vehicle movement request to the vehicle or a vehicle-mounted terminal in the vehicle, to park the vehicle into the new parking space. When the user rejects moving the vehicle, the server 200 may notify a next user, so that the next user determines whether to park into the parking space with the higher parking priority. A sequence of notifying a user may be determined based on parking duration. For example, a user with shorter parking duration may be notified first, and then a user with longer parking duration may be notified. In an example, when the user is not satisfied with a parking space in which the user currently parks, the user may alternatively manually choose another available parking space on the terminal device. Then, the server may treat the parking space selected by the user as a parking space whose parking priority is higher.

After receiving the vehicle movement request delivered by the server 200, the vehicle may be parked into the new parking space.

It may be understood that sequence numbers of the steps do not mean execution sequences in the foregoing embodiments. The execution sequences of the processes should be determined based on functions and internal logic of the processes, and should not be construed as any limitation on the implementation processes of embodiments of this disclosure. In addition, embodiments and/or the steps in embodiments described above may be combined based on an actual situation. A solution obtained through combination is still within the protection scope of this disclosure. In addition, an execution body in the foregoing method may be replaced based on an actual situation. A solution obtained through replacement is still within the protection scope of this disclosure.

The following describes a parking space recommendation apparatus provided in embodiments of this disclosure based on the method in the foregoing embodiments.

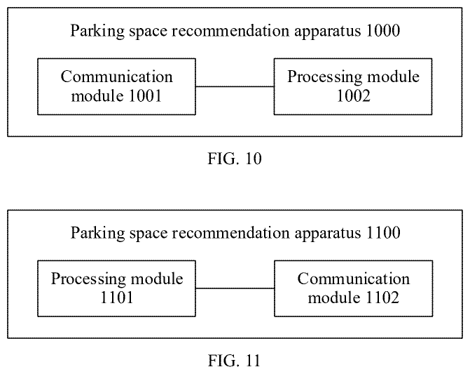

For example, FIG. 10 is a diagram of a structure of a parking space recommendation apparatus according to an embodiment of this disclosure. For example, the parking space recommendation apparatus may be deployed on a first vehicle, but is not limited thereto, for example, deployed on the foregoing vehicle 100. As shown in FIG. 10, the parking space recommendation apparatus 1000 includes a communication module 1001 and a processing module 1002. The communication module 1001 is configured to, when the first vehicle enters a parking lot, send a parking space recommendation request to a server, and receive a map of the parking lot and information about an available parking space and an unavailable parking space in the parking lot from the server (that is, delivered by the server), where the available parking space includes a temporary parking space, and the temporary parking space is obtained by dividing an area in the parking lot other than a marked parking space. The processing module 1002 is configured to display the map of the parking lot, and present the available parking space and the unavailable parking space on the map.

In some embodiments, on the map, an identifier of the available parking space is different from an identifier of the unavailable parking space.

In some embodiments, on the map and in the available parking space, first identifiers of different temporary parking spaces are different, and the first identifier indicates a parking priority of the temporary parking space.

In some embodiments, the available parking space further includes a marked parking space; and on the map and in the available parking space, an identifier of the marked parking space is different from an identifier of the temporary parking space.

In some embodiments, second identifiers of different marked parking spaces are different, and the second identifier indicates a parking priority of the marked parking space.

In some embodiments, a parking priority of the marked parking space is higher than the parking priority of the temporary parking space.

In some embodiments, an identifier of a vehicle is displayed on the unavailable parking space on the map.

In some embodiments, the processing module 1002 is further configured to, after presenting the available parking space on the map, in response to an operation of selecting a first parking space from the available parking space by a user, park the first vehicle into the first parking space.

In some embodiments, the communication module 1001 is further configured to, after the processing module 1002 parks the first vehicle into the first parking space, send, to the server, a local map of the parking lot constructed by the first vehicle and perception data related to a sensor of the first vehicle, so that the server updates information about the map of the parking lot and the available parking space and the unavailable parking space in the parking lot.

In some embodiments, after the processing module 1002 parks the first vehicle into the first parking space, and when the first vehicle blocks a leaving route for a second vehicle to leave a second parking space, the communication module 1001 is further configured to receive a vehicle movement request from the server; and the processing module 1002 is further configured to park the first vehicle into a third parking space recommended by the server.

In some embodiments, after the processing module 1002 parks the first vehicle into the first parking space, and when the first vehicle blocks a leaving route for a second vehicle to leave a second parking space, the communication module 1001 is further configured to receive a vehicle movement request from the server; and the processing module 1002 is further configured to drive the first vehicle away from the first parking space for staying outside the leaving route; and when the second vehicle passes through the first parking space, park the first vehicle into the first parking space, or when the second vehicle leaves the second parking space and a route for parking the first vehicle into the second parking space does not affect a subsequent leaving route of the second vehicle, park the first vehicle into the second parking space.

It should be understood that the foregoing apparatus is configured to perform the method performed by the vehicle in the foregoing embodiments. An implementation principle and technical effect of a corresponding program module in the apparatus are similar to those described in the foregoing method. For a working process of the apparatus, refer to a corresponding process in the foregoing method. Details are not described herein again.

For example, FIG. 11 is a diagram of a structure of another parking space recommendation apparatus according to an embodiment of this disclosure. For example, the parking space recommendation apparatus may be deployed on a server, but is not limited thereto, for example, deployed on the foregoing server 200. As shown in FIG. 11, the parking space recommendation apparatus 1100 includes a processing module 1101 and a communication module 1102. The processing module 1101 is configured to divide an area in a parking lot other than a marked parking space to obtain at least one temporary parking space. The communication module 1102 is configured to receive a parking space recommendation request from a first vehicle; and send, to the first vehicle, a map of the parking lot into which the first vehicle travels, and information about an available parking space and an unavailable parking space in the parking lot, where the available parking space includes a temporary parking space.

In some embodiments, the communication module 1102 is further configured to receive, from the first vehicle, perception data related to a sensor of the first vehicle and a local map of the parking lot. The processing module 1101 is configured to update, based on the perception data related to the sensor of the first vehicle, the information about the available parking space and the unavailable parking space in the parking lot; and update the map of the parking lot based on the local map of the parking lot.

In some embodiments, before the communication module 1102 sends, to the first vehicle, the map of the parking lot into which the first vehicle travels, and the information about the available parking space and the unavailable parking space in the parking lot, the communication module 1102 is further configured to receive, from another vehicle, a local map of the parking lot and perception data related to a sensor of the other vehicle, where the other vehicle is at least one vehicle other than the first vehicle; and the processing module 1101 is further configured to generate the map of the parking lot based on the local map of the parking lot sent by the other vehicle; and recognize the available parking space and the unavailable parking space in the parking lot based on the perception data related to the sensor of the other vehicle.

In some embodiments, after recognizing the available parking space in the parking lot, the processing module 1101 is further configured to divide parking priorities of parking spaces included in the available parking space.

In some embodiments, the processing module 1101 is further configured to indicate, when a first parking space in which the first vehicle is located blocks a leaving route for a second vehicle to leave a second parking space, the first vehicle to travel from the first parking space to a third parking space, and stay in the third parking space, where the third parking space is not on the leaving route.

In some embodiments, the processing module 1101 is further configured to indicate, when a first parking space in which the first vehicle is located blocks a leaving route for a second vehicle to leave a second parking space, the first vehicle to travel to an area outside the leaving route; and indicate, when the second vehicle passes through the first parking space, the first vehicle to be parked into the first parking space; or indicate, when the second vehicle leaves the second parking space and a route for parking the first vehicle into the second parking space does not affect a subsequent leaving route of the second vehicle, the first vehicle to be parked into the second parking space.

In some embodiments, after the second vehicle leaves the second parking space, the processing module 1101 is further configured to update the information about the available parking space and the unavailable parking space in the parking lot.

It should be understood that the foregoing apparatus is configured to perform the method performed by the server in the foregoing embodiments. An implementation principle and technical effect of a corresponding program module in the apparatus are similar to those described in the foregoing method. For a working process of the apparatus, refer to a corresponding process in the foregoing method. Details are not described herein again.

An embodiment of this disclosure further provides a parking space recommendation apparatus. The parking space recommendation apparatus may include one or more processors and a memory. The memory is configured to store one or more programs. When the one or more programs are executed by the one or more processors, the one or more processors are enabled to implement the method performed by the vehicle in the foregoing embodiments, or implement the method performed by the server in the foregoing embodiments. For example, when the parking space recommendation apparatus can implement the method performed by the vehicle in the foregoing embodiments, the parking space recommendation apparatus may be but is not limited to a vehicle-mounted terminal on the vehicle. When the parking space recommendation apparatus can implement the method performed by the vehicle in the foregoing embodiments, the parking space recommendation apparatus may be but is not limited to a server, for example, a cloud server.

An embodiment of this disclosure further provides a vehicle. The vehicle may be configured with a parking space recommendation apparatus that can implement the method performed by the vehicle in the foregoing embodiments. For example, the vehicle may be the vehicle 100.

Based on the method in the foregoing embodiments, an embodiment of this disclosure provides a computer-readable storage medium, including computer program instructions. When the computer program instructions are executed by a computing device, the computing device performs the method performed by the vehicle or the server in the foregoing embodiments. For example, the computer-readable storage medium may be any usable medium that can be stored by the computing device, or a data storage device like a data center, including one or more usable media. The usable medium may be a magnetic medium (for example, a floppy disk, a hard disk, or a magnetic tape), an optical medium (for example, a digital video disk (DVD)), a semiconductor medium (for example, a solid-state drive (SSD)), or the like.

Based on the method in the foregoing embodiments, an embodiment of this disclosure provides a computer program product including instructions. When the instructions are run by a computing device, the computing device is enabled to perform the method performed by the vehicle or the server in the foregoing embodiments.

It can be understood that the processor in embodiments of this disclosure may be a central processing unit (CPU), or may be another general-purpose processor, a digital signal processor (DSP), an application-specific integrated circuit (ASIC), a field-programmable gate array (FPGA) or another programmable logic device, a transistor logic device, a hardware component, or any combination thereof. The general-purpose processor may be a microprocessor or any processor.

The method steps in embodiments of this disclosure may be implemented in a hardware manner, or may be implemented in a manner of executing software instructions by the processor. The software instructions may include corresponding software modules. The software modules may be stored in a random-access memory (RAM), a flash memory, a read-only memory (ROM), a programmable ROM (PROM), an erasable PROM (EPROM), an electrically erasable PROM (EEPROM), a register, a hard disk, a removable hard disk, a compact disk ROM (CD-ROM), or any other form of storage medium well-known in the art. For example, a storage medium is coupled to a processor, so that the processor can read information from the storage medium and write information into the storage medium. In an example, the storage medium may alternatively be a component of the processor. The processor and the storage medium may be disposed in an ASIC.

All or some of the foregoing embodiments may be implemented by using software, hardware, firmware, or any combination thereof. When software is used to implement the foregoing embodiments, all or some of embodiments may be implemented in a form of a computer program product. The computer program product includes one or more computer instructions. When the computer program instructions are loaded and executed on a computer, the procedure or functions according to embodiments of this disclosure are all or partially generated. The computer may be a general-purpose computer, a dedicated computer, a computer network, or another programmable apparatus. The computer instructions may be stored in a computer-readable storage medium, or may be transmitted through the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a SSD), or the like.

It may be understood that various numbers in embodiments of this disclosure are merely used for differentiation for ease of description, and are not used to limit the scope of embodiments of this disclosure.

It should be noted that, the foregoing embodiments are intended for describing the technical solutions of this disclosure, but not for limiting this disclosure. Although this disclosure is described in detail with reference to the foregoing embodiments, a person of ordinary skill in the art should understand that modifications can still be made to the technical solutions described in the foregoing embodiments or equivalent replacements can be made to some technical features thereof, without departing from the protection scope of the technical solutions in embodiments of this disclosure.

1. A parking space recommendation method, comprising:
receiving a map of a parking lot in which a first vehicle currently travels;
receiving first information about at least one available parking space in the parking lot, wherein the at least one available parking space comprises a temporary parking space that is based on a division of an area in the parking lot other than a marked parking space; and
receiving second information about an unavailable parking space in the parking lot, wherein;
displaying the map of the parking lot; and
presenting, on the map, the unavailable parking space, the at least one available parking space, and a first parking priority of the available parking space.

2. The parking space recommendation method of claim 1, further comprising displaying a first identifier of the at least one available parking space and a second identifier of the unavailable parking space on the map.

3. The parking space recommendation method of claim 1, further comprising displaying first identifiers of temporary parking spaces on the map that are different, wherein the first identifiers indicate second parking priorities of the temporary parking spaces.

4. The parking space recommendation method of claim 1, wherein the available parking space further comprises a first marked parking space, and wherein the parking space recommendation method further comprise displaying a first identifier of the marked parking space on the map and a second identifier of the temporary parking space on the map.

5. The parking space recommendation method of claim 4, further comprising displaying third identifiers of second marked parking spaces on the map that are different and wherein the third identifiers indicate second parking priorities of the second marked parking spaces.

6. The parking space recommendation method of claim 4, wherein a third parking priority of the first marked parking space is higher than a fourth parking priority of the temporary parking space.

7. The parking space recommendation method of claim 1, wherein the first parking priority is based on at least one of an occupation duration of the unavailable parking space or a historical parking habit of a user of the first vehicle.

8. The parking space recommendation method of claim 1, further comprising displaying, on the map, an identifier of a vehicle in the unavailable parking space.

9. The parking space recommendation method of claim 1, wherein after presenting the at least one available parking space, the parking space recommendation method further comprises:
receiving a user selection operation of a first parking space from the at least one available parking space; and
parking the first vehicle in the first parking space in response to receiving the user selection operation.

10. A parking space recommendation method, comprising:
receiving a vehicle movement request;
receiving information about at least one available parking space and a first parking priority of the at least one available parking space; and
moving a first vehicle from a first parking space in a parking lot in which the first vehicle is currently located to a second parking space in the parking lot in response to the vehicle movement request,
wherein the first parking space is the at least one available parking space,
wherein a second parking priority of the second parking space is higher than the first parking priority, and
wherein the second parking space comprises a temporary parking space that is based on a division of an area in the parking lot other than a marked parking space.

11. The parking space recommendation method of claim 10, wherein the second parking space more closely meets a historical parking habit of a user of the first vehicle than the first parking space, or a first impact of the first parking space on a second vehicle is greater than a second impact of the second parking space on the second vehicle.

12. The parking space recommendation method of claim 10, further comprising further receiving the vehicle movement request after the information is updated and no vehicle is parked in the second parking space or when a user chooses on a terminal device to move the first vehicle to the second parking space.

13. The parking space recommendation method of claim 10, wherein the second parking space has a second vehicle, wherein the parking space recommendation method further comprises:
further receiving the vehicle movement request when the first vehicle blocks a leaving route for the second vehicle to leave the second parking space; and
further moving the first vehicle by:
driving the first vehicle away from the first parking space for staying outside the leaving route; and
parking the first vehicle into the first parking space when the second vehicle leaves the second parking space and a route for parking the first vehicle into the second parking space does not affect a subsequent leaving route of the second vehicle.

14. A vehicle, comprising:
a parking space recommendation apparatus comprising:
a memory configured to store executable instructions; and
at least one processor coupled to the memory and configured to execute the instructions to cause the parking space recommendation apparatus to:
receive a map of a parking lot in which the vehicle currently travels;
receive first information about at least one available parking space in the parking lot, wherein the at least one available parking space comprises a temporary parking space that is based on a division of an area in the parking lot other than a marked parking space; and
receive second information about an unavailable parking space in the parking lot;
display the map of the parking lot; and
present, on the map, the unavailable parking space, the at least one available parking space, and a first parking priority of the available parking space.

15. The vehicle of claim 14, wherein the at least one processor is further configured to execute the instructions to cause the parking space recommendation apparatus to display a first identifier of the at least one available parking space and a second identifier of the unavailable parking space on the map.

16. The vehicle of claim 14, wherein the at least one processor is further configured to execute the instructions to cause the parking space recommendation apparatus to display first identifiers of temporary parking spaces on the map that are different, and wherein the first identifiers indicate second parking priorities of the temporary parking spaces.

17. The vehicle of claim 14, wherein the temporary parking space comprises a second identifier, and wherein the at least one available parking space further comprises the marked parking space comprising a third identifier, and wherein the at least one processor is further configured to execute the instructions to cause the parking space recommendation apparatus to display the second identifier on the map and the third identifier on the map.

18. The vehicle of claim 17, wherein fourth identifiers of second marked parking spaces are different and indicate second parking priorities of the second marked parking spaces.

19. The vehicle of claim 17, wherein the marked parking space comprises a third parking priority, wherein the temporary parking space comprises a fourth parking priority, and wherein the third parking priority is higher than the fourth parking priority.

20. The vehicle of claim 19, wherein the first parking priority is based on at least one of an occupation duration of the unavailable parking space or a historical parking habit of a user of the vehicle.
